(19) United States
(12) Patent Application Publication
(10) Pub. No.: US 2014/0249829 A1
(43) Pub. Date: Sep. 4, 2014

(54) CONFIGURABLE RESOURCE UTILIZATION DETERMINATOR AND ESTIMATOR

(71) Applicant: 3M INNOVATIVE PROPERTIES COMPANY, St. Paul, MN (US)

(72) Inventors: Richard F. Averill, Seymour, CT (US); Jon Eisenhandler, Bristol, CT (US); David E. Gannon, Waterford, CT (US); Anthony J. Quain, Alexandria, VA (US); James A. Switalski, Cheshire, CT (US); James C. Vertrees, Annapolis, MD (US)

(73) Assignee: 3M INNOVATIVE PROPERTIES COMPANY, ST. PAUL, MN (US)

(21) Appl. No.: 13/782,245

(22) Filed: Mar. 1, 2013

(51) Int. Cl. G06Q 50/22; G06Q 10/06

(52) U.S. Cl. CPC G06Q 50/22; G06Q 10/06
USPC 705/2

(57) ABSTRACT

In one example, this disclosure describes a method determining a resource utilization value, via one or more computers. The method may comprise receive dated patient healthcare data comprising information about one or more of diagnosed conditions, delivered services or procedures, severity indicators, or resource utilization data associated with any delivered services or procedures. The method may further comprise receiving selection input comprising one or more resource type parameters. After receiving selection input, the method may further comprise determining a resource utilization value based at least in part on the patient healthcare data and the selection input.

### TECHNICAL FIELD

The invention relates to techniques and systems for determining and estimating resource utilization in healthcare settings.

### BACKGROUND

In the healthcare field, insurance companies or Medicare and Medicaid, i.e., payors, reimburse healthcare professionals and facilities based on provided services and the equipment used in treating a patient for a specific disease or health problem. Some payors employ a system where they reimburse the healthcare professionals and facilities a set amount based on particular diagnosed diseases or health problems. By reimbursing only a set amount, the payors incentivize the healthcare professionals and facilities to use the available resources efficiently to treat the patient. However, most of these systems include many safeguards for ensuring that set reimbursement amounts are not so low as to make treatment unprofitable. In some examples, the payors adjust the set reimbursement amount based on many individualized patient factors, such as the severity of the disease or health problem, the age of the patient, and whether the patient has any other concurrent diseases or health problems. Further, many times the payor reimburses multiple professionals and facilities throughout treatment of a single patient. Problems can arise in determining reimbursement amounts to particular professionals and facilities and in establishing appropriate reimbursement rates.

### SUMMARY

This disclosure describes systems and techniques for determining resource utilization values via one or more computers. The techniques and systems described may determine resource utilization values based on user input. The user input may define one or more parameters. The system and techniques may determine one or more resource utilization values based on the parameters. By allowing a user to select the parameters upon which the system and techniques may determine a resource utilization value, the system and techniques may help to determine past resource utilization and estimate future resource utilization. This configurability in determining resource utilization values may be useful to payors in establishing reimbursement rates for healthcare professionals and healthcare facilities.

In one example, this disclosure describes a method of determining a resource utilization value. The method comprises receiving, at the one or more computers, dated patient healthcare data comprising information about one or more of: diagnosed conditions, delivered services or procedures, severity indicators, or resource utilization data associated with any delivered services or procedures, receiving, at the one or more computers, selection input comprising one or more resource type parameters, and determining, via the one or more computers, a resource utilization value based at least in part on the patient healthcare data and the selection input.

In another example, this disclosure describes a computerized healthcare system for determining a resource utilization value, the system comprising a computer that includes a processor and a memory, wherein the processor is configured to receive dated patient healthcare data comprising information about one or more of: diagnosed conditions, delivered services or procedures, severity indicators, or resource utilization data associated with any delivered services or procedures, receive selection input comprising one or more resource type parameters, and determine a resource utilization value based at least in part on the patient healthcare data and the selection input.

In another example, this disclosure describes a device for determining resource utilization values. In this example, the device comprises means for receiving, at the one or more computers, dated patient healthcare data comprising information about one or more of: diagnosed conditions, delivered services or procedures, severity indicators, or resource utilization data associated with any delivered services or procedures, means for receiving, at the one or more computers, selection input comprising one or more resource type parameters, and a means for determining, via the one or more computers, a resource utilization value based at least in part on the patient healthcare data and the selection input.

The techniques of this disclosure may be implemented at least partially in hardware, such as a processor or discrete logic circuits. The techniques may also be implemented using aspects of software or firmware in combination with the hardware. If implemented at least partially in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable storage medium and loaded and executed in the processor. The processor may execute modules to perform the techniques of this disclosure, and the modules may comprise combinations of software and hardware, e.g., software routines executing on the processor.

Accordingly, this disclosure also contemplates a computer-readable storage medium comprising instructions that when executed in a processor cause the processor to determine a resource utilization value wherein upon execution, the instructions cause the processor to receive dated patient healthcare data comprising information about one or more of: diagnosed conditions, delivered services or procedures, severity indicators, or resource utilization data associated with any delivered services or procedures, receive selection input comprising one or more resource type parameters, and determine a resource utilization value based at least in part on the patient healthcare data and the selection input.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example of a stand alone computer system for determining resource utilization values.

FIG. 2 is a block diagram illustrating a distributed system for determining resource utilization values.

FIG. 3 is a flow diagram illustrating a technique of this disclosure.

FIG. 4 is a flow diagram illustrating a technique of this disclosure.

FIG. 5 is a flow diagram illustrating a technique of this disclosure

FIG. 6 is a flow diagram illustrating a technique of this disclosure.

### DETAILED DESCRIPTION

This disclosure describes systems and techniques for determining and estimating resource utilization values via one or more computers. The systems and techniques may be used by a healthcare payor, such as a healthcare insurance company or Medicare and Medicaid, to assist in establishing reimbursement rates for healthcare professionals and healthcare facilities. In other instances, the systems and techniques may be used by healthcare professionals and facilities to determine or estimate a reimbursement amount they expect to receive from a payor for treatment of one or more patients.

Currently, many payors establish reimbursement rates or limits based on particular diagnosed diseases or other health problems. For instance, a payor may reimburse healthcare professionals and facilities a set amount based on a diagnosis of a broken forearm. This reimbursement amount is generally determined to cover the cost of treatment surrounding mending the broken arm. Other payors may reimburse healthcare professionals and facilities based on treatment actually given, up to a set limit. These rates or limits are generally established so as to encourage efficient utilization of healthcare resources. However, establishing reimbursements or limits can become complicated and convoluted for patients with multiple diagnosed diseases or other health problems. For instance, treatment for one disease or health problem may also help treat, or in some cases worsen, other diseases or health problems. This problem adds to the complexity associated with establishing reimbursement budgets or limits on treatment for particular diseases or health problems.

Furthermore, payors may need to reimburse multiple healthcare professionals and facilities over the course of treatment for a single patient. Each professional and facility may provide a variety of different services and equipment. In some instances, it may become difficult to keep track of reimbursement amounts for healthcare professionals and facilities, and even more difficult to determine or estimate reimbursement rates or limits for treatment of patients. When multiple professionals or facilities are involved, overlap in the care can also occur.

The systems and techniques described herein may assist payors in determining or estimating reimbursement amounts or limits. For example, the described systems and techniques may allow a user, such as a payor, to configure techniques for determining reimbursements associated with a particular patient. The systems and techniques may allow a user to enter one or more various selection parameters. Based on these selection parameters, the systems and techniques may parse patient healthcare data and determine a resource utilization value based on the parameters. This resource utilization value may represent the value of reimbursements to the various healthcare professionals and facilities involved in treating the patient associated with the patient healthcare data. The system and techniques may further estimate resource utilization values based on selection parameters. For example the system and techniques may determine resource utilization values associated with a number of patients suffering from similar diseases or other health problems. Based on these determinations, the system and techniques may estimate future resource utilization values for similar patients suffering from the disease or health problem. Determining and estimating these resource utilization values based on user specified selection parameters may assist a user reimbursing or establishing reimbursement rates or budgets for healthcare professionals and facilities.

In one example, a method includes, receiving, at the one or more computers, dated patient healthcare data comprising information about one or more of: diagnosed conditions, delivered services or procedures, severity indicators, or resource utilization data associated with any delivered services or procedures. The method may further include receiving, at the one or more computers, selection input comprising one or more resource type parameters. After receiving selection input, the method may determine, via the one or more computers, a resource utilization value based at least in part on the patient healthcare data and the selection input.

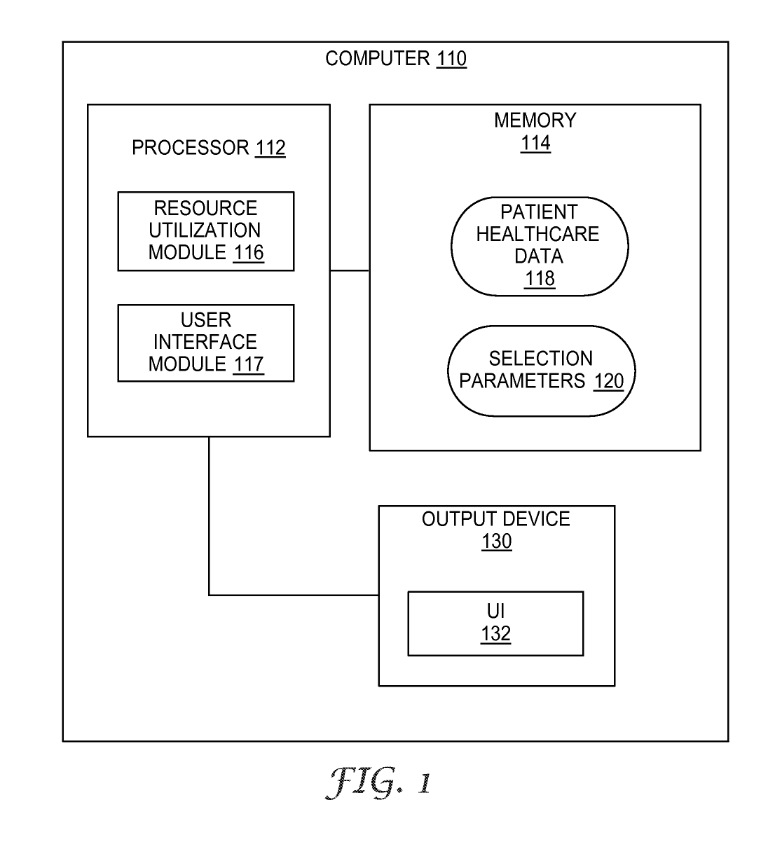

FIG. 1 is a block diagram illustrating an example of a stand-alone computerized system for determining healthcare service episodes consistent with this disclosure. The system comprises computer 110 that includes a processor 112, a memory 114, and an output device 130. Computer 110 may also include many other components. The illustrated components are shown merely to explain various aspects of this disclosure.

Output device 130 may comprise a display screen, although this disclosure is not necessarily limited in this respect, and other types of output devices may also be used. Memory 114 stores patient healthcare data 118, which may comprise data collected in documents such as patient healthcare records, among other information. Memory 114 also includes selection parameters 120. Processor 112 is configured to include a user interface module 117 and a resource utilization module 116 that executes techniques of this disclosure with respect to patient healthcare data 118 and selection parameters 120.

Processor 112 may comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 114 may store program instructions (e.g., software instructions) that are executed by processor 112 to carry out the techniques described herein. In other examples, the techniques may be executed by specifically programmed circuitry of processor 112. In these or other ways, processor 112 may be configured to execute the techniques described herein.

Output device 130 may comprise a display screen, and may also include other types of output capabilities. In some cases, output device 130 may generally represent both a display screen and a printer in some cases. Resource utilization module 116 and, in some examples, user interface module 117, may be configured to cause output device 130 to output patient healthcare data 118, selection parameters 120, or other data. In some instances, output device 130 may include a user interface (UI) 132. UI 132 may comprise an easily readable interface for displaying the output information. Outputting patient healthcare data 118, selection parameters 120, or other data may assist payors in determining or estimating resource utilization associated with patient healthcare data 118.

In one example, resource utilization module 116 receives patient healthcare data 118. Patient healthcare data 118 may include information included in a patient healthcare record or any other documents or files describing a patient encounter with a healthcare facility. For example, when a patient has an encounter with a healthcare facility, such as during an inpatient admission or an outpatient visit, all of the information gathered during the encounter may be consolidated into a patient healthcare record. In one example, such a patient healthcare record may include any procedures performed, any medications prescribed, any notes written by a physician or nurse, and generally any other information concerning the patient encounter with the healthcare facility. Further, patient healthcare data 118 may also include information from healthcare claims forms. For patients who have had multiple encounters with the healthcare system, a patient healthcare record may contain information associated with each of those separate encounters. Additionally, all the information included in patient healthcare data 118 may be associated with particular dates. As one illustrative example, a healthcare encounter may comprise an office visit occurring on Mar. 20, 2005. All of the information included in patient healthcare data 118 associated with this encounter may include date information of Mar. 20, 2005 (or whatever date is appropriate for each particular piece of information).

Patient healthcare data 118 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Other standard healthcare codes that may be included in patient healthcare data 118 may be Diagnostic Related Group (DRG) codes or National Drug Codes (NDCs). These DRG codes may represent a specific category of disease or health problem the patient suffers from or has suffered from in the past.

In some examples, patient healthcare data 118 may include resource utilization data. Resource utilization data may include any charge amounts or reimbursement amounts associated with the healthcare services included in patient healthcare data 118. As one illustrative example, patient healthcare data 118 may include information relating to a healthcare service event comprising a yearly physical exam. In some examples, the included information may comprise information about any charges issued by the healthcare professional and facility involved in administering the physical exam and any reimbursement amounts provided by one or more payors. In other examples, these charge amounts and reimbursement amounts may be determined based on the specific standard healthcare codes included in patient healthcare data 118.

In some examples, resource utilization module 116 may receive selection input from a user. For example, user interface module 117 may output a user interface (UI) 132 to output device 130. A user, viewing UI 132, may enter selection input comprising one or more selection parameters. User interface module 117 may then communicate the parameters to resource utilization module 116. In this manner, a user may enter one or more parameters to configure resource utilization module 116 in determining and estimating resource utilization values. For example, a resource utilization value may comprise the totality of the charges issued by healthcare professionals and facilities for treating a patient. In other examples, a resource utilization value may comprise the totality of reimbursement paid to healthcare professionals and facilities for treatment of a patient. In other examples, a resource utilization value may comprise other metrics of resource utilization associated with treating a patient in a healthcare setting. Resource utilization module 116 may further communicate the received selection parameters to memory 114 where the selection parameters may be stored at selection parameters 120.

In some examples the parameters may comprise one or more resource type parameters. Resource type parameters may comprise particular categories of resources resource utilization module 116 may include in estimating a resource utilization value. For example, resource type parameters may comprise categories such as an Inpatient Hospital Facility category, a Hospice Facility category, a Skilled Nursing Facility category, an Extended Care Facility category, an Outpatient Hospital Facility category, an Outpatient ER Facility category, an Outpatient a Surgery Facility category, a Home Health category, a Professional Ancillary category, a Professional Inpatient category, a Professional Outpatient category, a Professional Extended Care category, a Professional Office category, a Retail Pharmacy category, an Outpatient/Professional Pharmacy category, an Outpatient/Professional DME category, an Outpatient/Professional Laboratory category, an Outpatient/Professional Diagnostic Radiology category, and a Miscellaneous Facility category. As described previously, patient healthcare data 118 may comprise information regarding charge amounts or reimbursement amounts. Patient healthcare data 118 may further include information separating those charge or reimbursement amounts into separate categories. In some examples, those separate categories may correspond to the resource type parameters. In examples where patient healthcare data 118 includes standard healthcare codes, those healthcare codes may specify, explicitly or implicitly, to which resource type parameters the specific charges or reimbursement amounts belong.

In at least one example, resource utilization module 116 may determine resource utilization values based on the received patient healthcare data 118 and the received selection input. Resource utilization module 116 may receive patient healthcare data 118 associated with a single patient. Resource utilization module 116 may also determine all of the charges or reimbursement amounts within patient healthcare data 118 associated with the patient and the received resource type parameters and may further determine a resource utilization value based on that determination. For example, as described previously, patient healthcare data 118 may include identifying information associating particular information in patient healthcare data 118 as associated with particular resource type categories. For instance, patient healthcare data 118 may include various charges or reimbursements identified by healthcare codes. In some examples, these healthcare codes may identify the particular resource type categories to which the associated reimbursements or charges belong. In other examples, memory 114 may contain a set of predefined associations between healthcare codes and resource type categories. Resource utilization module 118 may receive the associations from memory and identify to which resource type categories the various reimbursements and charges belong based on those received associations.

In one illustrative example, patient healthcare data 118 may include information including charges of one-thousand dollars for an inpatient admission for a surgical procedure to repair a broken arm, another three-thousand dollar charge for use of hospital facilities and services during the inpatient admission for the surgical procedure, and a seven-hundred dollar charge for an outpatient office visit for cast removal. In this example, a user may enter selection input consisting of an inpatient admission resource type parameter. In such an example, resource utilization module 116 may receive all of the information from patient healthcare data 118, including all three charges, but may determine a resource utilization value of four-thousand dollars if resource utilization module 116 determined that only the inpatient surgical procedure and the inpatient facility and services charges fall within the inpatient admission category.

Although the above example revolved around a single patient, as patient healthcare data 118 may contain healthcare data associated with multiple patients, resource utilization module 116 may determine resource utilization values for multiple patients. For example, a user may enter one or more resource type parameters, as described above, and resource utilization module 116 may determine resource utilization values for each patient based only on charges or reimbursement associated with those entered resource type parameters. In this way, a user may configure resource utilization module 116 to determine resource utilization values based on entered selection input. This configurability may assist users, such as payors, in determining and estimating reimbursement amounts.

The selection input may also comprise other parameters. Another example parameter or parameters may comprise patient characteristic data. In some examples, patient characteristic data may include demographic parameters such as age, gender, race, height, weight, and other demographic information. In at least one example, patient characteristic data may also include information about disease burden. For example, patient characteristic data may comprise one or more disease or other health problem categories.

In some examples, resource utilization module 116 may determine resource utilization values based on the received patient characteristic data. For example, resource utilization module 116 may only determine resource utilization values based on patient healthcare data 118 associated with patients satisfying the received patient characteristic parameters. As one illustrative example, the patient characteristic data may comprise demographic parameters selecting a male gender and an age of 60 or older, along with an inpatient admission resource type category. In such an example, resource utilization module 116 may determine a resource utilization value based only on patient healthcare data 118 associated with male patients who are 60 or older. Further, resource utilization module 116 may only include charges or reimbursement amounts associated with inpatient admissions in the resource utilization determination.

As another illustrative example, a user may enter patient characteristic data comprising a diabetes category. In such an example, resource utilization module 116 may only determine resource utilization values based on patient healthcare data 118 associated with patients who suffer from diabetes.

Another selection parameter or set of selection parameters may define a time period selection. For example, a user may enter a specific time period. This time period may represent a number of days, months, or even years. Resource utilization module 116 may determine resource utilization values based only on patient healthcare data 118 associated with dates within the received time period selection. As one illustrative example, a user may enter a time period selection of Oct. 1, 2011 to Jul. 1, 2012. In such an example, resource utilization module 116 may determine resource utilization values based on patient healthcare data 118 associated with dates within the time period. For example, patient healthcare data 118 associated with a particular patient may include charges for two separate inpatient admissions, the first occurring on May 14, 2010 and the second occurring on Jan. 20, 2012. In such an example, resource utilization module 116 may only include the inpatient admission occurring on Jan. 20, 2012 in determining a resource utilization value. In this example, any charges incurred on dates that fall outside of the selected time period may be excluded from the resource utilization value determination (or possibly included at a reduced percentage).

In some examples, the selection input may further comprise a patient parameter. For example, the patient parameter may comprise a specific patient. In such examples, resource utilization module 116 may determine a resource utilization value for patient healthcare data 118 associated with the patient identified by the patient parameter.

Although the above description generally describes the selection parameters as separate, one or more, or all of them may be combined. Accordingly, resource utilization module 116 may determine one or more resource utilization values based on more than one input selection parameter. As one illustrative example, a user may enter resource type parameters, patient characteristic data including demographic information and a disease category, and a time period selection. In such an example, resource utilization module 116 may determine resource utilization values based on patient healthcare data 118 associated with patients who satisfy the entered demographic parameters and the entered disease category parameter. Further, resource utilization module 116 may determine a resource utilization value based only on patient healthcare data 118 falling within the entered time period parameter and associated with the entered resource type categories. In examples where resource utilization module 116 receives a patient parameter, resource utilization module 116 may only determine a resource utilization value based on the other selection parameters for the specified patient.

In some examples, resource utilization module 116 may estimate one or more resource utilization values based on selection input. For example, resource utilization module 116 may determine resource utilization values based on the entered selection input as described above. Resource utilization module 116 may also determine an average resource utilization value based on all determined resource utilization values. This average resource utilization value may represent an estimate of future resource utilization values for patients consistent with the entered selection parameters. As one illustrative example, a user may enter selection parameters comprising an inpatient admission category, patient characteristic data including demographic information selecting a male gender and ages of 60 and older, and a time period of Jan. 1, 2012 to Jan. 1, 2013. In such an example, resource utilization module 116 may determine resource utilization values based on patient healthcare data 118 associated with patients satisfying the entered demographic information. Further, resource utilization module 116 may only take into consideration patient healthcare data 118 falling within the entered time period in determining resource utilization values. Further, resource utilization module 116 may determine an average resource utilization value based on the determined resource utilization values. In the illustrative example, the average resource utilization value may be an estimate of a resource utilization value associated with inpatient admissions for male patients 60 and older over a one year time period.

In this manner, resource utilization module 116 may assist a user in estimating future resource utilization values by allowing a user to enter specific selection input and determine average resource utilization values based on the selection input. The described configurability may assist a user, such as a payor, in establishing reimbursement rates or limits by allowing the user to more easily determine resource utilization values for specific patients, or groups of patients, and based on specific selection input.

In other examples, resource utilization module 116 may determine resource utilization values based on processed patient healthcare data. For example, patient healthcare data 118 may also include processed patient healthcare data. Various processing methods may process healthcare data such as patient healthcare data 118 into one or more disease group categories or temporal group categories. In on example, a processing method may categorize the patient healthcare data into disease group categories, wherein the disease group categories include any patient healthcare data 118 associated with a specific disease or other health problem. As one illustrative example, all patient healthcare data 118 related to treatment for a broken bone may be grouped into a single disease group category. In another example, a processing method may group all patient healthcare data 118 for a single year into a single temporal group category. Other processing methods may group patient healthcare data 118 into different temporal group categories based on different time periods.

In examples where resource utilization module 116 determines resource utilization values based on processed patient healthcare data, resource utilization module 116 may receive further selection parameters. In some examples, an additional parameter or parameters may comprise a specific disease group category. For example, a user may enter a parameter comprising a heart disease category. Resource utilization module 116 may determine a resource value based only on the patient healthcare data 118 included in the heart disease category. In this manner, resource utilization module 116 may determine a resource utilization value associated with a single disease category. Determining a resource utilization value based on a single disease category may assist a user, such as a payor, in establishing reimbursement rates or limits based around treatment for a specific disease.

In other examples, another selection parameter may comprise a specific time period parameter. For example, a user may select a specific time period group category comprising patient healthcare data 118 included within the specific time period group. In one illustrative example, a user may enter a time period category comprising the time period of Oct. 1, 2011 and Mar. 15, 2012. In such an example, resource utilization module 116 may determine a resource utilization value based on the patient healthcare data 118 included within the selected time period.

One example processing method may be found in U.S. Pat. No. 7,127,407 to Averill et al, the entirety of which is incorporated herein by reference, which describes processing healthcare data such as patient healthcare data 118 by creating or categorizing the data into a multi-level categorical hierarchy. In at least one example, patient healthcare data 118 may be processed into Major Disease Categories (MDCs) or other categories. The data may further be categorized into Clinical Risk Groups (CRGs) and each CRG may have an associated severity level indicator. In some examples, patient healthcare data 118 may include healthcare service episodes associated with one or more specific CRGs and severity level indicators. The severity level indicator may provide an indication of a relative severity level of the disease or health problem associated with the CRG or determined healthcare service episode. In other examples, the severity level indicator may indicate the severity level of a trigger healthcare service event. In such examples, a healthcare service episode may further include a severity level indicator, which indicates the severity of the trigger healthcare service event which initiated the healthcare service episode.

In an example where patient healthcare data 118 is further processed into a multi-level categorical hierarchy, the selection input may comprise further parameters. In some examples, the selection input may further comprise a CRG parameter. The CRG parameter may specify a specific CRG assignment and, in some examples, a severity level indicator. In some example, the severity level indicator may indicate a relative severity of a disease or health problem a patient suffers from. In such examples, resource utilization module 116 may determine a resource utilization value based on the selected CRG assignment and severity level indicator. As one illustrative example, resource utilization module 116 may receive patient healthcare data 118 processed into various categories. Resource utilization module 116 may further determine a resource utilization value based only on the patient healthcare data 118 associated with the selected CRG. Resource utilization module 116 may also adjust the determined resource utilization value based on the severity level indicator. For example, in the case of a high severity level indicator, resource utilization module 116 may adjust the determined resource utilization value to a higher value.

Another example processing method is described in co-pending and commonly assigned U.S. application Ser. No. ______, entitled “DEFINING PATIENT EPISODES BASED ON HEALTHCARE EVENTS,” bearing attorney Docket Number 71408US0002, and filed on the same day as this application, the entirety of which is incorporated herein by reference, which describes processing healthcare data such as patient healthcare data 118 into temporally non-overlapping healthcare service episodes comprising one or more healthcare service events. In some examples, patient healthcare data 118 may be processed into temporally non-overlapping episodes. Specific information included in patient healthcare data 118 may indicate certain trigger healthcare service events. Based on these trigger healthcare service events, patient healthcare data 118 may be processed into temporally non-overlapping healthcare service episodes comprising a time period surrounding a trigger healthcare service event. For example, a trigger healthcare service event may comprise an inpatient admission, and the healthcare service episode may comprise a time period surrounding the trigger healthcare service event. In some examples, the healthcare service episode may comprise the time period prior to, after, or partially prior to and/or after the trigger healthcare service event.

In some examples where patient healthcare data 118 is further processed into healthcare service episodes, the selection input may comprise one or more additional parameters or possibly different parameters than those set forth above. For example, a user may enter a parameter comprising a specific healthcare service episode or a specific healthcare service trigger event. In some examples, the selection input may further comprise an episode window parameter. The episode window parameter may define a specific length of time. In some examples, resource utilization module 116 may receive patient healthcare data 118 which has been processed into specific healthcare service episodes or include determined trigger healthcare service events. Resource utilization module 116 may determine a resource utilization value based on patient healthcare data 118 included in the selected healthcare service episode. In other examples, resource utilization module 116 may determine a resource utilization value based on the patient healthcare data 118 included within a length of time consistent with the entered episode window parameter and surrounding the entered trigger healthcare service events. In one illustrative example, a user may enter a trigger healthcare service event comprising an inpatient admission and an episode window parameter of three months. In the illustrative example, resource utilization module 116 may determine one or more resource utilization values based on patient healthcare data 118 included in a three month time period surrounding an inpatient admissions.

In some examples, the selection input may further comprise a patient parameter. In such examples, resource utilization module 116 may determine a resource utilization value for patient healthcare data 118 associated with the identified patient.

In the above described examples, the selection parameters described with respect to patient healthcare data 118 that have been further processed have been described as separate. However, one or more, or all of the described parameters may be combined. Further, in examples where patient healthcare data 118 has been processed, selection input may also comprise parameters such as those described with respect to unprocessed patient healthcare data 118. Accordingly, resource utilization module 116 may determine one or more resource utilization values based on more than one selection parameter. These parameters may describe patient healthcare data 118 or patient healthcare data 118 that has been further processed into categories, time periods, or healthcare service episodes. In examples where resource utilization module 116 receives a selected patient, resource utilization module 116 may only determine a resource utilization value based on the other selection parameters for the identified patient.

In some examples, resource utilization module 116 may estimate one or more resource utilization values based on the selection input. For example, resource utilization module 116 may determine resource utilization values based on the entered selection input as described above. Resource utilization module 116 may also determine an average resource utilization value based on all determined resource utilization values. This average resource utilization value may represent an estimate of future resource utilization values for patients consistent with the entered selection input. In the examples where patient healthcare data 118 has been further processed, the average resource utilization value may represent an estimated resource utilization value for the specific selected disease group, time period, healthcare service episode, or for a time period surrounding a specific trigger healthcare service event.

In some examples where resource utilization module 116 determines resource utilization values for processed patient healthcare data 118, resource utilization module 116 may determine an adjustment factor associated with each healthcare service episode. This adjustment factor may be a function of a plurality of parameters, for example, CRG parameters, resource type parameters, patient characteristic data, trigger healthcare service event or healthcare service event parameters, or other described parameters. As described above, resource utilization module 116 may determine resource utilization values associated with patient healthcare data 118 based on all of the entered selection input and an average resource utilization value based on the determined resource utilization values. Resource utilization module 116 may further determine an adjustment factor for each group of patient healthcare data 118 identified by the entered selection input. For example, for each group of patient healthcare data 118 identified by the entered selection parameters, resource utilization module 116 may divide the determined resource utilization value associated with each healthcare service episode by the average resource utilization value. The resulting unit-less parameter may be the adjustment factor. In this manner, resource utilization module 116 may determine an adjustment factor signifying how much more or less resources a particular group of patient healthcare data 118 required as compared to other similar groups.

In this manner, resource utilization module 116 may assist a user in determining resource utilization values and estimating future resource utilization values based processed patient healthcare data 118. This may allow a user, such as a payor, flexibility in which particular data to include in determining or estimating resource utilization values. This flexibility in manipulating resource utilization module 116 in determining resource utilization values may assist a user, such as a payor, in establishing reimbursement rates or limits by allowing the user to more easily determine resource utilization values for specific patients, or groups of patients, and based on the specific selection input.

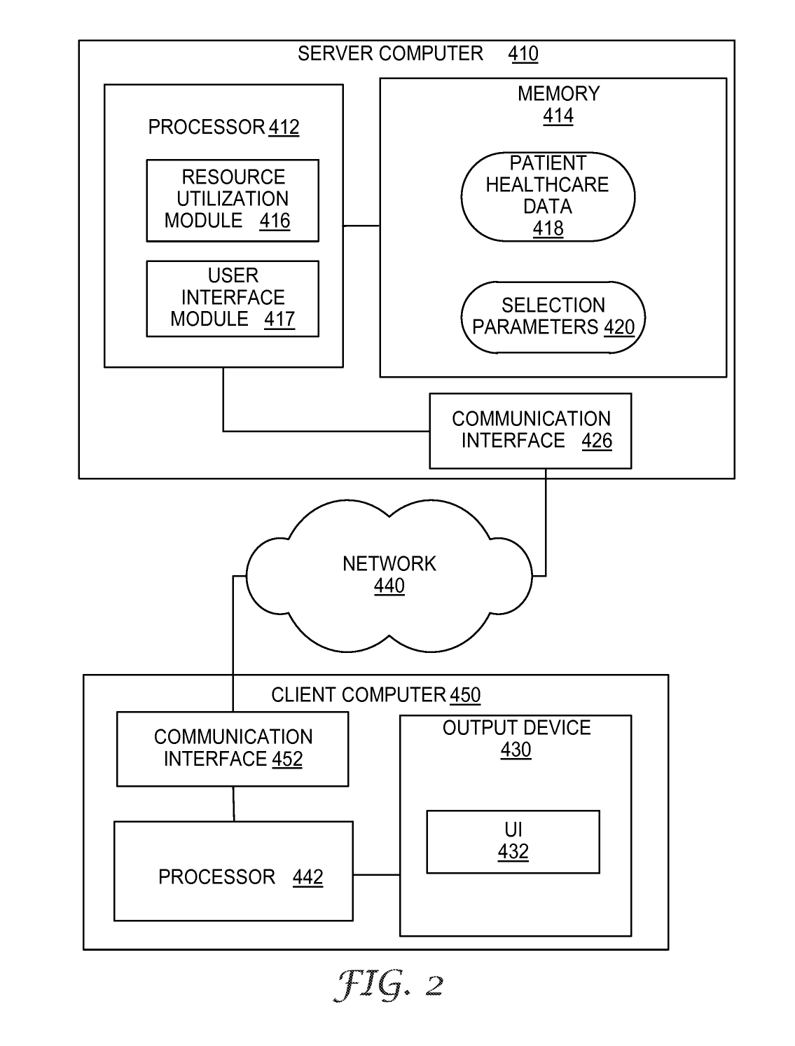

FIG. 2 is a block diagram of a distributed system that includes a server computer 210 and a client computer 250 that communicate via a network 240. In the example of FIG. 2, network 240 may comprise a proprietary on non-proprietary network for packet-based communication. In one example, network 240 comprises the Internet, in which case communication interfaces 226 and 252 may comprise interfaces for communicating data according to transmission control protocol/internet protocol (TCP/IP), user datagram protocol (UDP), or the like. More generally, however, network 240 may comprise any type of communication network, and may support wired communication, wireless communication, fiber optic communication, satellite communication, or any type of techniques for transferring data between a source (e.g., server computer 210) and a destination (e.g., client computer 240).

Server computer 210 may perform the techniques of this disclosure, but the user may interact with the system via client computer 250. Server computer 210 may include a processor 212, a memory 214, and a communication interface 226. Client computer 250 may include a communication interface 252, a processor 242 and an output device 230. Of course, client computer 250 and server computer 210 may include many other components. The illustrated components are shown merely to explain various aspects of this disclosure.

Output device 230 may comprise a display screen, although this disclosure is not necessarily limited in this respect and other output devices may also be used. Memory 214 stores patient healthcare data 218, which may comprise data collected in documents such as patient healthcare records, among other information. Memory 214 may further store selection parameters 220. Processor 212 of server computer 210 is configured to include a resource utilization module 216 that executes techniques of this disclosure with respect to patient healthcare data 218.

Processors 212 and 242 may each comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 214 may store program instructions (e.g., software instructions) that are executed by processor 212 to carry out the techniques described herein. In other examples, the techniques may be executed by specifically programmed circuitry of processor 212. In these or other ways, processor 212 may be configured to execute the techniques described herein.

Output device 230 on client computer 250 may comprise a display screen, and may also include other types of output capabilities. For example, output device 230 may generally represent both a display screen and a printer in some cases. Resource utilization module 216 may be configured to cause output device 230 of client computer 250 to output patient healthcare data 218, selection parameters 220, or resource utilization values. User interface 232 may be generated, e.g., as output on a display screen, so as to allow a user enter various selection parameters or other information.

Similar to the stand alone example of FIG. 1, in the distributed example of FIG. 2, resource utilization module 216 may determine healthcare services episodes based on patient healthcare data 218. Resource utilization module 218 may further determine resource utilization values. In some examples, resource utilization module 216 may determine resource utilization values based at least in part on received selection input. Resource utilization module 216 may receive such selection input from client computer 250. For example, a user may enter the selection input at user interface (UI) 232. Again, communication interfaces 226 and 252 allow for communication between server computer 210 and client computer 250 via network 240. In this way, resource utilization module 216 may execute on server computer 210 but may receive input from client computer 250. A user operating on client computer 250 may log-on or otherwise access episode module 216 of server computer 210, such as via a web-interface operating on the Internet or a propriety network, or via a direct or dial-up connection between client computer 250 and server computer 210. In some cases, data displayed on output device 230 may be arranged in web pages served from server computer 210 to client computer 250 via hypertext transfer protocol (HTTP), extended markup language (XML), or the like.

In one example, resource utilization module 216 receives patient healthcare data 218. Patient healthcare data 218 may include any of the information described with respect to patient healthcare data 118. As an example, patient healthcare data 218 may comprise information included in a patient healthcare record or any other documents or files describing a patient encounter with a healthcare facility. In some examples, patient healthcare data 218 may include one or more standard healthcare codes, such as ICD, CPT, HCPCS, DRG, nad NDC codes. In still other examples, patient healthcare data 218 may include resource utilization data. For example, resource utilization data may include any charge amounts or reimbursement amounts associated with the healthcare services included in patient healthcare data 218.

In some examples, resource utilization module 216 may receive selection input from a user. For example, user interface module 217 may output a user interface (UI) 232 to communication interface 226. Communication interface 226 may communicate UI 232 to communication interface 252 over network 240. Communication interface 252 may then send UI 232 to processor 242. Processor 242 may then cause output device 230 to display UI 232 to the user. A user, viewing UI 132, may enter selection input comprising one or more selection parameters. Processor 242 may then cause communication interface 252 to communicate the entered selection parameters to communication interface 226 over network 240. Communication interface 226 may, in turn, communicate the entered selection parameters to processor 212 and resource utilization module 216. In this manner, a user may enter one or more parameters to configure resource utilization module 216 in determining and estimating resource utilization values. Resource utilization module 216 may further communicate the received selection parameters to memory 214 where the selection parameters may be stored at selection parameters 220.

The entered selection input may be any of the parameters described above with respect to FIG. 1. For example, the selection input may include resource type parameters. These parameters may comprise categories such as an Inpatient Hospital Facility category, a Hospice Facility category, a Skilled Nursing Facility category, an Extended Care Facility category, an Outpatient Hospital Facility category, an Outpatient ER Facility category, an Outpatient a Surgery Facility category, a Home Health category, a Professional Ancillary category, a Professional Inpatient category, a Professional Outpatient category, a Professional Extended Care category, a Professional Office category, a Retail Pharmacy category, an Outpatient/Professional Pharmacy category, an Outpatient/Professional DME category, an Outpatient/Professional Laboratory category, an Outpatient/Professional Diagnostic Radiology category, and a Miscellaneous Facility category. These parameters may indicate which resource categories resource utilization module 216 may include in determining a resource utilization value.

In one example, resource utilization module 216 may determine resource utilization values based on the received patient healthcare data 218 and the resource type parameters. Resource utilization module 216 may receive patient healthcare data 218 associated with a single patient. Resource utilization module 216 may also determine all of the charges or reimbursement amounts within patient healthcare data 218 associated with the received parameters and may further determine a resource utilization value based on that determination.

Although the above description revolved around a single patient, as patient healthcare data 218 may contain healthcare data associated with multiple patients, resource utilization module 216 may determine resource utilization values for multiple patients. For example, a user may enter one or more resource type category parameters, and resource utilization module 216 may determine resource utilization values for each patient based only on charges or reimbursement associated with the received resource type category parameters. In this way, a user may configure resource utilization module 216 to determine resource utilization values based on entered selection input. This configurability may assist users, such as payors, in establishing reimbursement amounts.

In some examples, the selection input may also comprise other parameters. Another example parameter or parameters comprise patient characteristic data. In some examples, patient characteristic data may include demographic parameters such as age, gender, race, height, weight, and other demographic information. In at least one example, patient characteristic data may also include information about disease burden. For example, patient characteristic data may comprise one or more disease or other health problem categories. In still other examples, selection input may comprise other parameters. In at least one example, the selection input may comprise a time period parameter. In other examples, selection input may comprise a patient parameter.

In all of these examples, resource utilization module 216 may determine a resource utilization value based on the input parameters. In the examples that include patient characteristic data, resource utilization module 216 may determine a resource utilization value based on the patient characteristic data. For example, a user may enter demographic parameters or a disease category parameter, and resource utilization module 216 may determine a resource utilization value based on patient healthcare data 218 associated with patients that satisfy the patient characteristic data. In examples that include a time period parameter defining a period of time, resource utilization module 216 may determine a resource utilization value based on patient healthcare data 218 that falls within the time period specified by the time period parameter. In examples that include a patient parameter, resource utilization module 216 may determine a resource utilization value based on patient healthcare data 218 associated with the patient identified by the patient parameter.

Although the above description generally describes the selection parameters as separate, one or more, or all of them may be combined. Accordingly, resource utilization module 216 may determine one or more resource utilization values based on more than one input selection parameter. As one illustrative example, a user may enter resource type parameters, patient characteristic data including demographic information and a disease category, and a time period selection. In such an example, resource utilization module 216 may determine resource utilization values based on patient healthcare data 218 associated with patients who satisfy the demographic parameters and the disease category parameter. Furthermore, resource utilization module 216 may determine a resource utilization value based on patient healthcare data 218 falling within the entered time period and associated with the resource type parameters. In examples where resource utilization module 216 receives a patient parameter, resource utilization module 216 may only determine a resource utilization value based on the other selection parameters for the patient identified by the patient parameter.

As described above with respect to FIG. 1, in some examples, resource utilization module 216 may estimate one or more resource utilization values based on selection input. For example, resource utilization module 216 may determine resource utilization values based on the entered selection input as described above. Resource utilization module 216 may also determine an average resource utilization value based on all determined resource utilization values, for example, if resource utilization module 216 determines resource utilization values for multiple patients. This average resource utilization value may represent an estimate of future resource utilization values for patients consistent with the entered selection input.

In this manner, resource utilization module 216 may assist a user in estimating future resource utilization values by allowing a user to enter specific selection input and determine resource utilization values based on the selection input. The described configurability may assist a user, such as a payor, in establishing reimbursement rates or limits by allowing the user to more easily determine resource utilization values for specific patients, or groups of patients, and based on the specific selection input.

In other examples, resource utilization module 216 may determine resource utilization values based on processed patient healthcare data. For example, patient healthcare data 218 may also include processed patient healthcare data. Various processing methods may process healthcare data such as patient healthcare data 218 into one or more disease group categories or temporal group categories. In on example, a processing method may categorize the patient healthcare data into disease group categories, wherein the disease group categories include any patient healthcare data 218 associated with a specific disease or other health problem. Other processing methods may group patient healthcare data 218 into different temporal group categories based on different time periods.

In examples where resource utilization module 216 determines resource utilization values based on processed patient healthcare data, resource utilization module 216 may receive further selection parameters. In some examples, an additional parameter or parameters may comprise a specific disease group category. For example, a user may enter a parameter comprising a heart disease category. Resource utilization module 216 may then determine a resource utilization value based on patient healthcare data 218 included in the heart disease category. In this manner, resource utilization module 216 may determine a resource utilization value associated with a single disease category. Determining a resource utilization value based on a single disease category may assist a user, such as a payor, in establishing reimbursement rates or limits based around treatment for a specific disease.

In other examples, another selection parameter may define a specific time period. For example, a user may select a specific time period group comprising patient healthcare data 218 included within the specific time period group. In one illustrative example, a user may enter a time period defining the time period of Oct. 1, 2011 and Mar. 15, 2012. In such an example, resource utilization module 216 may determine a resource utilization value based on the patient healthcare data 218 included within the selected time period.

As described previously, one processing method may process the data into a multi-level categorical hierarchy. For example, patient healthcare data 218 may be processed into MDCs or other categories, as described with respect to FIG. 1. Ultimately, patient healthcare data 218 may further be categorized into CRGs and each CRG may have an associated severity level indicator. In some examples, patient healthcare data 118 may include healthcare service episodes associated with one or more specific CRGs and severity level indicators. The severity level indicator may provide an indication of a relative severity level of the disease or health problem associated with the CRG or determined healthcare service episode. In other examples, the severity level indicator may indicate the severity level of a trigger healthcare service event. In such examples, a healthcare service episode may further include a severity level indicator, which indicates the severity of the trigger healthcare service event which initiated the healthcare service episode.

In an example where patient healthcare data 218 is further processed into a multi-level categorical hierarchy, the selection input may comprise further parameters. In some examples, the selection input may further comprise a CRG parameter. The CRG parameter may specify a specific CRG and, in some examples, a severity level indicator. In some example, the severity level indicator may indicate a relative severity of a disease or health problem a patient suffers from. In such examples, resource utilization module 216 may determine a resource utilization value based on the selected CRG assignment and severity level indicator. As one illustrative example, resource utilization module 216 may receive patient healthcare data 218 processed into various categories. Resource utilization module 216 may further determine a resource utilization value based only on the patient healthcare data 218 associated with the selected CRG. Resource utilization module 216 may also adjust the determined resource utilization value based on the severity level indicator. For example, in the case of a high severity level indicator, resource utilization module 216 may adjust the determined resource utilization value to a higher value.

Another example processing method, as described previously with respect to FIG. 1, may process healthcare data such as patient healthcare data 218 into temporally non-overlapping healthcare service episodes comprising one or more healthcare service events. Information included in patient healthcare data 218 may indicate certain trigger healthcare service events. Based on these trigger healthcare service events, patient healthcare data 218 may be processed into temporally non-overlapping healthcare service episodes comprising a time period surrounding a trigger healthcare service event. For example, a trigger healthcare service event may comprise an inpatient admission, and the healthcare service episode may comprise a time period surrounding the trigger healthcare service event. In some examples, the healthcare service episode may comprise the time period prior to, after, or partially prior to and/or after the trigger healthcare service event.

In some examples where patient healthcare data 218 is further processed into healthcare service episodes, the selection input may comprise one or more additional or different parameters. For example, a user may enter a parameter comprising a specific healthcare service episode or a specific healthcare service trigger event. In some examples, the selection input may further comprise an episode window parameter. The episode window parameter may define a specific length of time. In some examples, resource utilization module 216 may receive patient healthcare data 218 which has been processed into specific healthcare service episodes or include determined trigger healthcare service events. Resource utilization module 216 may determine a resource utilization value based on patient healthcare data 218 included in the selected healthcare service episode. In other examples, resource utilization module 216 may determine a resource utilization value based on the patient healthcare data 218 included within a length of time consistent with the entered episode window parameter and surrounding the entered trigger healthcare service events. In one illustrative example, a user may enter a trigger healthcare service event comprising an inpatient admission and an episode window parameter of three months. In the illustrative example, resource utilization module 216 may determine a resource utilization value based on patient healthcare data 218 included in a three month time period surrounding any patient healthcare data 218 comprising an inpatient admission.

In some examples, the selection input may further comprise a patient parameter. For example the patient parameter may comprise a specific patient. In such examples, resource utilization module 116 may determine a resource utilization value for patient healthcare data 118 associated with the patient identified by the patient parameter.

In some examples, one or more, or all of the described parameters with respect to FIG. 2 may be combined. Accordingly, resource utilization module 216 may determine one or more resource utilization values based on more than one selection parameter. These parameters may describe patient healthcare data 218 or patient healthcare data 218 that has been further processed into categories, time periods, or healthcare service episodes. In examples where resource utilization module 216 receives a patient parameter, resource utilization module 216 may only determine a resource utilization value based on the other selection parameters for the patient identified by the patient parameter.

In some examples, resource utilization module 216 may estimate one or more resource utilization values based on the selection input. For example, resource utilization module 216 may determine resource utilization values based on the entered selection input as described above. Resource utilization module 216 may also determine an average resource utilization value based on all determined resource utilization values. This average resource utilization value may represent an estimate of future resource utilization values for patients consistent with the entered selection parameters. In the examples where patient healthcare data 218 has been further processed, the average resource utilization value may represent an estimated resource utilization value for the specific selected disease group, time period, healthcare service episode, or for a time period surrounding a specific trigger healthcare service event.

In some examples where resource utilization module 216 determines resource utilization values for processed patient healthcare data 218, resource utilization module 216 may determine an adjustment factor associated with each healthcare service episode. This adjustment factor may be a function of a plurality of parameters, for example, CRG parameters, resource type parameters, patient characteristic data, trigger healthcare service event or healthcare service event parameters, or other described parameters. As described above, resource utilization module 216 may determine resource utilization values associated with patient healthcare data 218 based on all of the entered selection input and an average resource utilization value based on the determined resource utilization values. Resource utilization module 216 may further determine an adjustment factor for each group of patient healthcare data 218 identified by the entered selection input. For example, for each group of patient healthcare data 218 identified by the entered selection parameters, resource utilization module 216 may divide the determined resource utilization value associated with each healthcare service episode by the average resource utilization value. The resulting unit-less parameter may be the adjustment factor. In this manner, resource utilization module 216 may determine an adjustment factor signifying how much more or less resources a particular group of patient healthcare data 218 required as compared to other similar groups.

In this manner, resource utilization module 216 may assist a user in determining resource utilization values and estimating future resource utilization values based processed patient healthcare data 218. This may allow a user, such as a payor, flexibility in which particular data to include in determining or estimating the resource utilization values. This flexibility in manipulating resource utilization module 216 in determining resource utilization values may assist a user, such as a payor, in establishing reimbursement rates or limits by allowing the user to more easily determine resource utilization values for specific patients, or groups of patients, and based on the specific selection parameters.

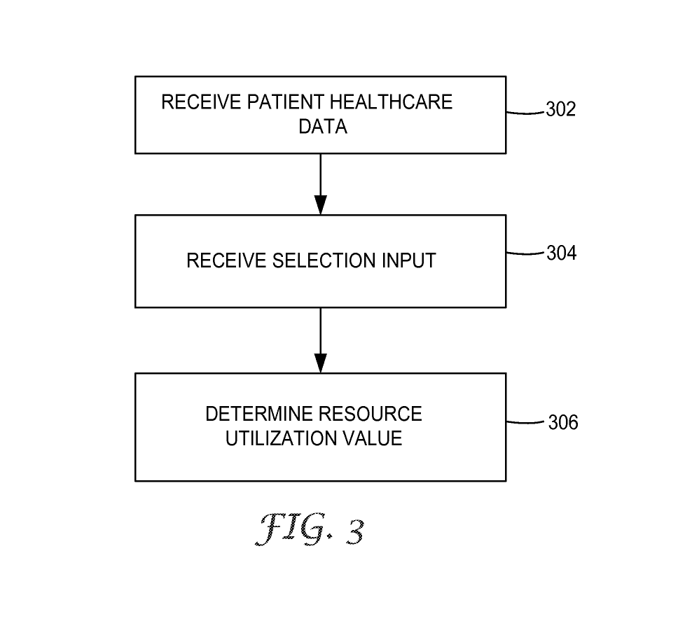

FIG. 3 is a flow diagram illustrating a technique of this disclosure. FIGS. 3-6 will be described from the perspective of computer 110 of FIG. 1, although the system of FIG. 2, or other systems, could also be used to perform such techniques. As shown in FIG. 3, resource utilization module 116 receives patient healthcare data 118 (302). Patient healthcare data 118 may include information included in a patient healthcare record or any other documents or files describing a patient encounter with a healthcare facility. For example, when a patient has an encounter with a healthcare facility, such as during an inpatient admission or an outpatient visit, all of the information gathered during the encounter may be consolidated into a patient healthcare record. In one example, such a patient healthcare record may include any procedures performed, any medications prescribed, any notes written by a physician or nurse, and generally any other information concerning the patient encounter with the healthcare facility. Further, patient healthcare data 118 may also include information from healthcare claims forms. In most examples, the information included in patient healthcare data 118 may be associated with a particular date. For example, information included in patient healthcare data 118 associated with an outpatient physical exam occurring on Mar. 20, 2005, may be associated with the date Mar. 20, 2005.

In some examples, Patient healthcare data 118 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Other standard healthcare codes that may be included in patient healthcare data 118 may be Diagnostic Related Group (DRG) codes or National Drug Codes (NDCs). These DRG codes may represent a specific category of disease or health problem the patient suffers from or has suffered from in the past.

Resource utilization module 116 may also receive selection input (304). Selection input may comprise one or more parameters, as described previously with respect to FIG. 1. For example, selection input may comprise resource type parameters, patient characteristic data, time period parameters, a patient parameter, a disease group category, or other parameters.

Based on the received patient healthcare data 118 and on the received selection input, resource utilization module 116 may determine a resource utilization value (306). In at least one example, resource utilization module 116 may determine all of the charges or reimbursement amounts within patient healthcare data 118 associated with the received parameters and may further determine a resource utilization value based on that determination.

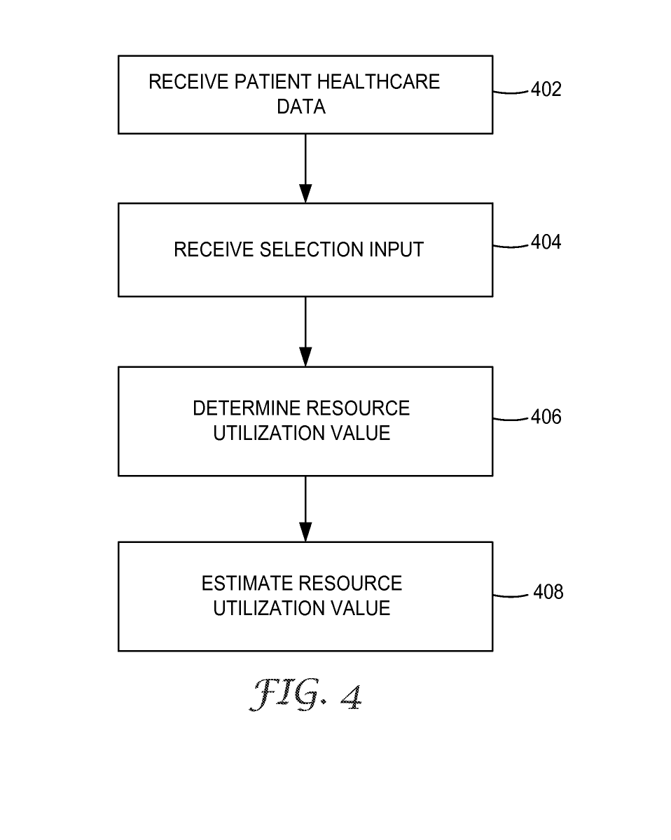

FIG. 4 is a flow diagram illustrating another technique of this disclosure. In this example, resource utilization module 116 may receive patient healthcare data 118 (402), receive selection input (404), and determine a resource utilization value (406) in a manner similar to that described with respect to FIG. 3. Furthermore, in this example, resource utilization module 116 may estimate a resource utilization value (408). For example, resource utilization module 116 may determine resource utilization values based on the entered selection input as described above. Resource utilization module 116 may also determine an average resource utilization value based on all of determined resource utilization values. This average resource utilization value may represent an estimate of future resource utilization values for patients consistent with the entered selection parameters.

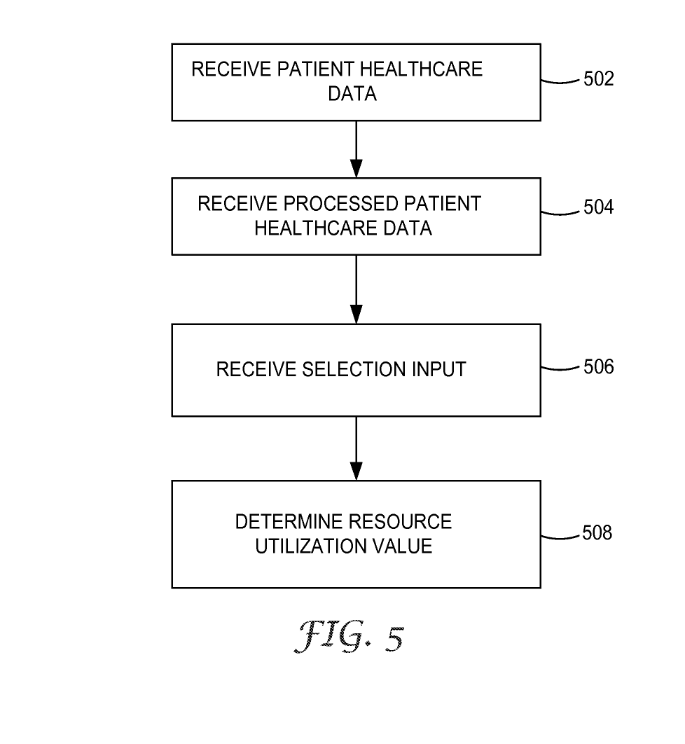

FIG. 5 is a flow diagram illustrating another technique of this disclosure. In this example, resource utilization module 116 may receive patient healthcare data 118 (502), as in FIG. 3. Resource utilization module 116 may further receive processed patient healthcare data (504). In some examples, patient healthcare data 118 may further include processed healthcare data.

Various processing methods may process healthcare data such as patient healthcare data 118 into one or more disease group categories or temporal group categories. In on example, a processing method may categorize the patient healthcare data into disease group categories, wherein the disease group categories include any patient healthcare data 118 associated with a specific disease or other health problem. In other examples, patient healthcare data 118 may include patient healthcare data processed into a multi-level categorical hierarchy, consistent with the description of FIG. 1. In still other examples, patient healthcare data 118 may include patient healthcare data processed into healthcare service episodes, also consistent with the description of FIG. 1.

Resource utilization module 116 may further receive selection input (506). The received selection input may be similar to the selection input described with respect to FIG. 3. However, resource utilization module 116 may receive additional or different selection input in the examples where resource utilization module 116 receives processed patient healthcare data. For example, additional or different parameters may include CRG parameters, a healthcare service episode parameter, a trigger healthcare service event parameter, or an episode window length parameter. These different or additional parameters may further help to configure resource utilization module 116 in determining resource utilization values (508).

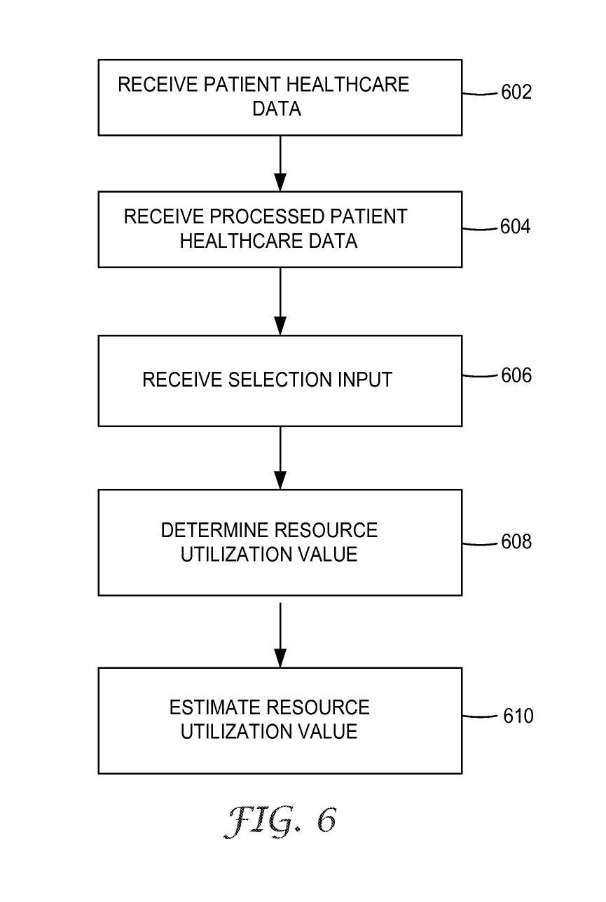

FIG. 6 is a flow diagram illustrating another technique of this disclosure. In this example, resource utilization module 116 may receive patient healthcare data 118 (602), receive processed healthcare data (604), receive selection input (606), and determine a resource utilization value (608) in a manner similar to that described with respect to FIG. 5. In this example, resource utilization module 116 may further determine an estimated resource utilization value (610). For example, resource utilization module 116 may determine resource utilization values based on the entered selection input as described above. Resource utilization module 116 may also determine an average resource utilization value based on all of determined resource utilization values. This average resource utilization value may represent an estimate of future resource utilization values for patients consistent with the entered selection parameters.

The techniques of this disclosure may be implemented in a wide variety of computer devices, such as servers, laptop computers, desktop computers, notebook computers, tablet computers, hand-held computers, smart phones, and the like. Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

These and other examples are within the scope of the following claims.

What is claimed:

1. A method of determining a resource utilization value, via one or more computers, the method comprising:
receiving, at the one or more computers, dated patient healthcare data comprising information about one or more of: diagnosed conditions, delivered services or procedures, severity indicators, or resource utilization data associated with any delivered services or procedures;
receiving, at the one or more computers, selection input comprising one or more resource type parameters; and
determining, via the one or more computers, a resource utilization value based at least in part on the patient healthcare data and the selection input.

2. The method of claim 1, wherein the selection input further comprises patient characteristic data.

3. The method of claim 2, wherein the patient characteristic data comprises demographic information.

4. The method of claim 2, wherein the patient characteristic data comprises one or more disease categories.

5. The method of claim 1, wherein the selection input further comprises a time period parameter.

6. The method of claim 1, wherein the resource type parameters comprise one or more of: an inpatient hospital facility category, a hospice facility category, a skilled nursing facility category, an extended care facility category, an outpatient hospital facility category, an outpatient ER facility category, an outpatient a surgery facility category, a home health category, a professional ancillary category, a professional inpatient category, a professional outpatient category, a professional extended care category, a professional office category, a retail pharmacy category, an outpatient/professional pharmacy category, an outpatient/professional DME category, an outpatient/professional laboratory category, an outpatient/professional diagnostic radiology category, and a miscellaneous facility category.

7. The method of claim 1, further comprising receiving, at the one or more computers, processed patient healthcare data.

8. The method of claim 7, wherein the selection input further comprises one or more disease group category parameters.

9. The method of claim 7, wherein the selection input further comprises one or more temporal group parameters.

10. The method of claim 7, wherein the selection input further comprises one or more temporally non-overlapping healthcare service episodes or trigger healthcare service events.

11. The method of claim 1, further comprising determining, via the one or more computers, an estimated resource utilization value based on one or more determined resource utilization parameters.

12. A computerized system for determining a resource utilization value, the system comprising a computer that includes a processor and a memory, wherein the processor is configured to:
receive dated patient healthcare data comprising information about one or more of: diagnosed conditions, delivered services or procedures, severity indicators, or resource utilization data associated with any delivered services or procedures;
receive selection input comprising one or more resource type parameters; and
determine a resource utilization value based at least in part on the patient healthcare data and the selection input.

13. The system of claim 12, wherein the selection input further comprises patient characteristic data.

14. The system of claim 13, wherein the patient characteristic data comprises demographic information.

15. The system of claim 13, wherein the patient characteristic data comprises one or more disease categories.

16. The system of claim 12, wherein the selection input further comprises a time period parameter.

17. The system of claim 12, wherein the resource type parameters comprise one or more of: an inpatient hospital facility category, a hospice facility category, a skilled nursing facility category, an extended care facility category, an outpatient hospital facility category, an outpatient ER facility category, an outpatient a surgery facility category, a home health category, a professional ancillary category, a professional inpatient category, a professional outpatient category, a professional extended care category, a professional office category, a retail pharmacy category, an outpatient/professional pharmacy category, an outpatient/professional DME category, an outpatient/professional laboratory category, an outpatient/professional diagnostic radiology category, and a miscellaneous facility category.

18. The system of claim 12, wherein the processor is further configured to receive processed patient healthcare data.

19. The system of claim 18, wherein the selection input further comprises one or more disease group category parameters.

20. The system of claim 18, wherein the selection input further comprises one or more temporal group parameters.

21. The system of claim 18, wherein the selection input further comprises one or more temporally non-overlapping healthcare service episodes or trigger healthcare service events.

22. The system of claim 12, wherein the processor is further configured to determine an estimated resource utilization value based on one or more determined resource utilization parameters.

23. A device for processing determining resource utilization values, the device comprising:
means for receiving, at the one or more computers, dated patient healthcare data comprising information about one or more of: diagnosed conditions, delivered services or procedures, severity indicators, or resource utilization data associated with any delivered services or procedures;
means for receiving, at the one or more computers, selection input comprising one or more resource type parameters; and
means for determining, via the one or more computers, a resource utilization value based at least in part on the patient healthcare data and the selection input.

24. A computer readable storage medium comprising instructions that when executed in a processor cause the processor to determine a resource utilization value, wherein upon execution the instructions cause the processor to:
receive dated patient healthcare data comprising information about one or more of: diagnosed conditions, delivered services or procedures, severity indicators, or resource utilization data associated with any delivered services or procedures;
receive selection input comprising one or more resource type parameters; and
determine a resource utilization value based at least in part on the patient healthcare data and the selection input.
